(19) United States
(12) Patent Application Publication
(10) Pub. No.: US 2023/0294035 A1
(43) Pub. Date: Sep. 21, 2023

(54) DEVICES, SYSTEMS, FACILITIES AND PROCESSES FOR CO2 DIRECT AIR CAPTURE USING DIRECT MOUNTED ADSORPTION BEDS

(71) Applicant: NEXT CARBON SOLUTIONS, LLC, Houston, TX (US)

(72) Inventors: Ivan Van der Walt, Conroe, TX (US); Ben Heichelbech, Houston, TX (US); Vikrum Subra, Houston, TX (US); Connor Rivard, Houston, TX (US)

(21) Appl. No.: 18/122,429

(22) Filed: Mar. 16, 2023

Related U.S. Application Data
(60) Provisional application No. 63/320,763, filed on Mar. 17, 2022.

(51) Int. Cl. B01D 53/04; B01D 53/26

(52) U.S. Cl. CPC B01D 53/0438; B01D 53/0446; B01D 53/261; B01D 2257/504; B01D 2258/06; B01D 2259/4009; B01D 2259/403; B01D 2257/80

(57) ABSTRACT

Devices, systems, facilities, and methods for direct air capture using adsorbent beds are disclosed. A exemplary system may include water adsorbent beds in fluid communication with an air cooled heat exchanger, and the water adsorbent beds adsorb water from a CO₂ containing gas stream from the air cooled heat exchanger. The system may include CO₂ adsorbent beds in fluid communication with the air cooled heat exchanger, and the CO₂ adsorbent beds adsorb the CO₂ from the CO₂ containing gas stream. A heat source provides heat energy to the water adsorbent beds and the CO₂ adsorbent beds to regenerate these adsorbent beds. A sequestration compression unit then compresses the saturated CO₂ from the CO₂ adsorbent beds.

### CROSS REFERENCE TO RELATED APPLICATIONS

The present application claims priority to U.S. Provisional Application No. 63/320,763, filed on Mar. 17, 2022, the entire content of which is being incorporated herein by reference.

### BACKGROUND

Industrial facilities contribute to greenhouse gases through various processes. Greenhouse gases comprise various gaseous components, such as carbon dioxide, methane, nitrous oxide, hydrofluorocarbons, perfluorocarbons, and sulfur hexafluoride, which absorb radiation, trap heat in the atmosphere and generally contribute to undesirable environmental greenhouse effects.

Industrial facilities often implement certain forms of hydrocarbon reduction technologies such as scrubbers and flares. However, typically these facilities do not have a dedicated process specifically designed to reduce most greenhouse gas emissions as well as implement synergies to reduce the cost of direct air capture.

### SUMMARY

The present disclosure provides devices, systems, facilities and processes that improve the overall efficiency of the facility and reduce greenhouse gas emissions.

In light of the disclosure herein, and without limiting the scope of the disclosure in any way, in an aspect of the present disclosure, which may be combined with any other aspect listed herein unless specified otherwise, an industrial facility may include one or more air cooled heat exchangers used for or in various parts of the industrial facility. The one or more air cooled heat exchangers may be configured to cool down plant processes and release warmer air to the atmosphere.

In an aspect of the present disclosure, which may be combined with any other aspect listed herein unless specified otherwise, adsorbent beds may be in fluid communication with the one or more air cooled heat exchangers by an active driving force from one or more air cooled heat exchanger fans. The one or more air cooled heat exchangers may provide active wind flow to the adsorbent beds. The adsorbent beds may include one or more water adsorbent beds. Additionally or alternatively, the adsorbent beds may include one or more CO₂ adsorbent beds.

In an aspect of the present disclosure, which may be combined with any other aspect listed herein unless specified otherwise, the wet air from the one or more air cooled heat exchangers may be sent to the one or more water adsorbent beds. The entrained water in the wet air from the cooled heat exchangers may be adsorbed by the one or more water adsorbent beds during the capture period. When the one or more water adsorbent beds have been saturated, steam may be used to desorb the water from the one or more water adsorbent beds, regenerating the one or more water adsorbent beds for the capture period. The steam used to desorb the water from the one or more water adsorbent beds may be supplied from or by a Heat Recovery Steam Generator (HRSG). The steam and desorbed water may be sent back to the inlet of the HRSG as part of the makeup stream.

In an aspect of the present disclosure, which may be combined with any other aspect listed herein unless specified otherwise, the dry air containing CO₂ from the one or more water adsorbent beds may be sent to one or more CO₂ adsorbent beds for the capture process. During the capture process, the CO₂ in the dry air may be adsorbed onto the one or more CO₂ adsorbent beds. When the one or more CO₂ adsorbent beds have been saturated with CO₂, steam may be used to desorb the CO₂ from the one or more CO₂ adsorbent beds. The steam used to desorb the CO₂ from the one or more CO₂ adsorbent beds may be supplied from or by the HRSG. The saturated CO₂ from the one or more CO₂ adsorbent beds may be sent to a blower and onward to a dehydration unit.

In an aspect of the present disclosure, which may be combined with any other aspect listed herein unless specified otherwise, the entrained steam used in the desorption of the CO₂ may be separated from the saturated CO₂ at the dehydration unit, and the water may be sent to the HRSG.

In an aspect of the present disclosure, which may be combined with any other aspect listed herein unless specified otherwise, the dry CO₂ from the dehydration unit may be sent to a meter/prover to determine the accurate amount of CO₂ that will be compressed and sequestered.

In an aspect of the present disclosure, which may be combined with any other aspect listed herein unless specified otherwise, the dry CO₂ may be sent to be compressed and sequestered.

In an aspect of the present disclosure, which may be combined with any other aspect listed herein unless specified otherwise, the heat source to generate the steam in the HRSG is from a hot flue gas from the industrial facility. In some embodiments, a system may comprise one or more CO₂ adsorbent beds in fluid communication with an air cooled heat exchanger, the one or more CO₂ adsorbent beds are configured to adsorb CO₂ from a CO₂ containing gas stream from the air cooled heat exchanger; a heat source configured to provide heat energy to the one or more CO₂ adsorbent beds to desorb the CO₂ from the one or more CO₂ adsorbent beds; and a sequestration compression unit configured to compress the CO₂ desorbed from the one or more CO₂ adsorbent beds.

In some embodiments, the system may comprise one or more water adsorbent beds in fluid communication with the air cooled heat exchanger, and the one or more water adsorbent beds may be configured to adsorb water from the CO₂ containing gas stream.

In some embodiments, the heat source may be configured to provide the heat energy to the one or more water adsorbent beds to desorb water from the one or more water absorbent beds.

In some embodiments, the heat source may be configured to generate the heat energy from waste heat from a flue gas.

In some embodiments, a system may comprise one or more water adsorbent beds in fluid communication with and mounted directly on top of an air cooled heat exchanger, the one or more water adsorbent beds are configured to adsorb water from a CO₂ containing gas stream from the air cooled heat exchanger to generate a dried CO₂ containing gas stream; one or more CO₂ adsorbent beds in fluid communication with and mounted downstream of the one or more water adsorbent beds, the one or more CO₂ adsorbent beds are configured to adsorb the CO₂ from the dried CO₂ containing gas stream; a heat source configured to provide a steam to each of the one or more water adsorbent beds and the one or more CO₂ adsorbent beds to desorb the water from the one or more water adsorbent beds and desorb the CO₂ from the one or more CO₂ adsorbent beds; and a sequestration compression unit configured to compress the CO₂ desorbed from the one or more CO₂ adsorbent beds.

In some embodiments, the system may comprise a meter downstream of the one or more CO₂ adsorbent beds and configured to measure a content of the CO₂ desorbed from the one or more CO₂ adsorbent beds.

In some embodiments, the heat source may be configured to generate the steam from waste heat from a flue gas.

In some embodiments, the heat source may be a waste heat recovery unit.

In some embodiments, the waste heat recovery unit may be a heat recovery steam generation unit.

In some embodiments, the system may comprise a blower and a dehydration unit, and the blower may be configured to move the CO₂ desorbed from the one or more CO₂ adsorbent beds to the dehydration unit.

In some embodiments, the dehydration unit may be configured to remove water entrained in the CO₂ desorbed from the one or more CO₂ adsorbent beds.

In some embodiments, the heat source may be a heat recovery steam generation unit, and the dehydration unit may be configured to send the removed water to the heat recovery steam generation unit for steam generation. In some embodiments, a process may comprise adsorbing, by one or more CO₂ adsorbent beds in fluid communication with an air cooled heat exchanger, CO₂ from a CO₂ containing gas stream; providing, by a heat source, heat energy to the one or more CO₂ adsorbent beds to desorb the CO₂ from the one or more CO₂ adsorbent beds; and compressing, by a sequestration compression unit, the CO₂ desorbed from the one or more CO₂ adsorbent beds.

In some embodiments, the process may comprise adsorbing, by one or more water adsorbent beds in fluid communication with the air cooled heat exchanger, water from the CO₂ containing gas stream.

In some embodiments, the process may comprise providing, by the heat source, the heat energy to the one or more water adsorbent beds to desorb water from the one or more water absorbent beds.

In some embodiments, providing the heat energy may comprise generating the heat energy from waste heat from a flue gas.

In some embodiments, the process may comprise generating additional heat energy from the desorbed water from the one or more water adsorbent beds.

In some embodiments, the process may comprise sending the additional heat energy to the heat source, and the heat source may be a heat recovery steam generation unit.

In some embodiments, a process may comprise adsorbing, by one or more water adsorbent beds in fluid communication with and mounted directly on top of an air cooled heat exchanger, water from a CO₂ containing gas stream from the air cooled heat exchanger to generate a dried CO₂ containing gas stream; adsorbing, by one or more CO₂ adsorbent beds in fluid communication with and mounted downstream of the one or more water adsorbent beds, the CO₂ from the dried CO₂ containing gas stream; providing, by a heat source, a steam to each of the one or more water adsorbent beds and the one or more CO₂ adsorbent beds to desorb the water from the one or more water adsorbent beds and desorb the CO₂ from the one or more CO₂ adsorbent beds; and compressing, by a sequestration compression unit, the CO₂ desorbed from the one or more CO₂ adsorbent beds.

In some embodiments, the process may comprise measuring, by a meter downstream of the one or more CO₂ adsorbent beds, a content of the CO₂ desorbed from the one or more CO₂ adsorbent beds.

In some embodiments, providing the steam may comprise generating the steam from waste heat from a flue gas.

In some embodiments, the process may further comprise generating an additional steam from the desorbed water from the one or more water adsorbent beds.

In some embodiments, the process may comprise sending the additional steam to the heat source, and the heat source may be a heat recovery steam generation unit.

In some embodiments, the process may comprise moving the CO₂ desorbed from the one or more CO₂ adsorbent beds, by a blower, to a dehydration unit.

In some embodiments, the process may comprise removing, by the dehydration unit, water entrained in the CO₂ desorbed from the one or more CO₂ adsorbent beds.

In some embodiments, the process may comprise sending the removed water from the dehydration unit to the heat source for steam generation, and the heat source is a heat recovery steam generation unit.

Each aspect, feature, and/or embodiment disclosed herein may be combined with any other aspect, feature, and/or embodiment described herein unless specified otherwise. Additional features and advantages of the disclosed devices, systems, and processes are described in and will be apparent from the following detailed description and the figures. The features and advantages described herein are not all-inclusive and in particular many additional features and advantages will be apparent to one of ordinary skill in the art in view of the figures and description. Also, any particular embodiment does not have to have all of the advantages listed herein. Moreover, it should be noted that the language used in the specification has been principally selected for readability and instructional purposes and not to limit the scope of the disclosed subject matter.

### BRIEF DESCRIPTION OF THE FIGURES

Understanding that the FIGURES depict only typical embodiments of the present disclosure and are not to limit the scope of the present disclosure, the present disclosure is described and explained with additional specificity and detail through the accompanying FIGURES. The figures are listed below.

FIG. 1 illustrates an exemplary schematic of a combined Direct Air Capture unit using mounted adsorbent beds with the CO₂ rich gas from the adsorbent beds being compressed and sent to sequestration/storage.

### DETAILED DESCRIPTION

The detailed description is exemplary only and does not describe every possible embodiment, as describing every possible embodiment would be impractical, if not impossible. One of ordinary skill in the art could implement numerous alternate embodiments, which would still fall within the scope of the present disclosure. Unless a term is expressly defined herein, there is no intent to limit the meaning of that term beyond its plain or ordinary meaning. To the extent that any term is referred to in a manner consistent with a single meaning, that is done for the sake of clarity only, and it is not intended that such term be limited to that single meaning.

All percentages expressed herein are by weight of the total weight of the composition unless expressed otherwise. As used herein, “about,” “approximately” and “substantially” are understood to refer to numbers in a range of numerals, for example the range of −10% to +10% of the referenced number, preferably −5% to +5% of the referenced number, more preferably −1% to +1% of the referenced number, most preferably −0.1% to +0.1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

As used in this disclosure and the appended claims, the singular forms “a,” “an” and “the” include plural referents unless the context clearly dictates otherwise. Thus, for example, reference to “an ingredient or “the ingredient” means “at least one ingredient” and includes two or more ingredients.

The words “comprise,” “comprises” and “comprising” are to be interpreted inclusively rather than exclusively. Likewise, the terms “include,” “including” and “or” should all be construed to be inclusive, unless such a construction is clearly prohibited from the context. Nevertheless, the compositions disclosed herein may lack any element that is not specifically disclosed herein. Thus, a disclosure of an embodiment using the term “comprising” includes a disclosure of embodiments “consisting essentially of” and “consisting of” the components identified. A composition “consisting essentially of” contains at least 75 wt. % of the referenced components, preferably at least 85 wt. % of the referenced components, more preferably at least 95 wt. % of the referenced components, most preferably at least 98 wt. % of the referenced components.

The terms “at least one of” and “and/or” used in the respective context of “at least one of X or Y” and “X and/or Y” should be interpreted as “X,” or “Y,” or “X and Y.” For example, “at least one of honey or chicory root syrup” should be interpreted as “honey without chicory root syrup,” or “chicory root syrup without honey,” or “both honey and chicory root syrup.”

Where used herein, the terms “example” and “such as,” particularly when followed by a listing of terms, are merely exemplary and illustrative and should not be deemed to be exclusive or comprehensive.

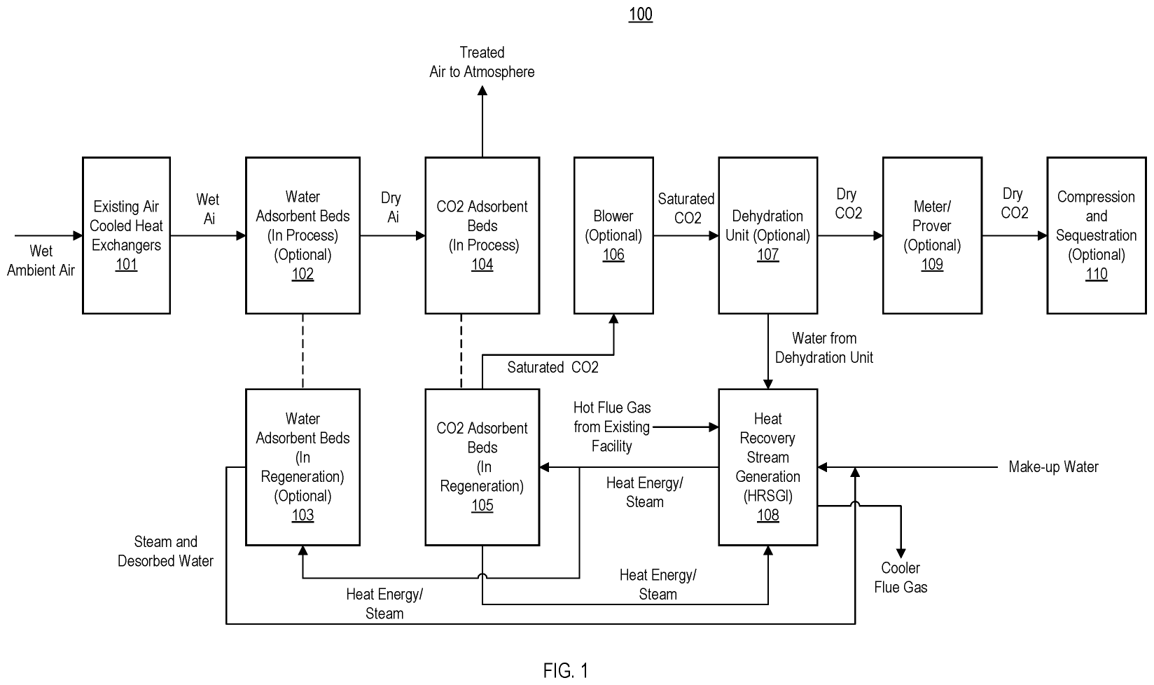

FIG. 1 illustrates an exemplary schematic of a system and a process of CO₂ direct air capture with adsorbent beds 100 with the captured CO₂ being sent to sequestration and/storage according to some aspects of the present disclosure.

A wet ambient air may be sent to one or more existing facility air coolers 101 to be used in cooling of plant processes. The one or more air coolers 101 may be one or more air cooled heat exchangers.

The warmer air from the one or more air coolers 101 may sent to one or more water adsorbent beds (in process) 102, so that the air flow from the one or more air coolers 101 is in fluid communication with the one or more water adsorbent beds (in process) 102. The one or more water adsorbent beds (in process) 102 may be directly mounted above the air coolers 101. In the one or more water adsorbent beds (in process) 102, water entrained in the wet air may be adsorbed, and a dry air may be generated from the one or more water adsorbent beds (in process) 102.

After the entrained water has been adsorbed, heat energy, such as steam, may be sent from a heat source 108 into the one or more water adsorbent beds (in regeneration) 103 to desorb the entrained water. The heat source may be a waste heat recover unit or an HRSG 108. The heat energy or steam and desorbed water may be sent back to the inlet stream of the HRSG 108 to be used as make-up water. Heat energy/power supplied to the HRSG 108 may be from a hot flue gas generated from existing plant processes.

The dry air from the one or more water adsorbent beds in process 102 may be sent to one or more CO₂ adsorbent beds (in process) 104 for the CO₂ to be adsorbed.

The air from the one or more air coolers 101 may be directly send to the one or more CO₂ adsorbent beds (in process) 104.

Once the one or more CO₂ adsorbent beds are saturated with CO₂, heat energy, such as steam, may be sent from the heat source, such as the HRSG 108 to the one or more CO₂ adsorbent beds (in regeneration) 105 to desorb the CO₂ from the one or more CO₂ adsorbent beds (in regeneration) 105. The treated air with the CO₂ removed may be sent to atmosphere.

The saturated CO₂, desorbed from the one or more CO₂ adsorbent beds (in regeneration) 105, may be sent to a blower 106 to be sent onward to a dehydration unit 107 to be dehydrated to become a dry CO₂. The heat energy or steam used to desorb the CO₂ may be separated from the one or more CO₂ adsorbent beds (in regeneration) 105 and sent to the hear source, such as the HRSG 108.

The CO₂ may be sent to a sequestration compression unit 110 to be compressed and sequestered. The CO₂ may be sent to a meter/prover 109 to be accurately measured before being sent to sequestration compression unit 110.

With the disclosed system, devices, and processes, the backpressure is eliminated on the air coolers as air can flow around the adsorbent beds. Furthermore, there is no additional heat required to regenerate the CO₂, which reduces the heat/power as the heat may be supplied by the hot flue gas from existing plant processes.

Each aspect, feature, and/or embodiment disclosed herein may be combined with any other aspect, feature, and/or embodiment described herein unless specified otherwise. The many features and advantages of the present disclosure are apparent from the written description. Further, since numerous modification and changes will readily occur to those skilled in the art, the present disclosure is not limited to the exact construction and operation as illustrated and described. Therefore, the described embodiments should be taken as illustrative and not restrictive, and the disclosure should not be limited to the details given herein. Each aspect of the present disclosure may be combined with any other aspect described herein unless specified otherwise.

1. A system comprising:
one or more CO₂ adsorbent beds in fluid communication with an air cooled heat exchanger, the one or more CO₂ adsorbent beds are configured to adsorb CO₂ from a CO₂ containing gas stream from the air cooled heat exchanger;
a heat source configured to provide heat energy to the one or more CO₂ adsorbent beds to desorb the CO₂ from the one or more CO₂ adsorbent beds; and
a sequestration compression unit configured to compress the CO₂ desorbed from the one or more CO₂ adsorbent beds.

2. The system of claim 1 further comprising one or more water adsorbent beds in fluid communication with the air cooled heat exchanger, and the one or more water adsorbent beds are configured to adsorb water from the CO₂ containing gas stream.

3. The system of claim 2, wherein the heat source is configured to provide the heat energy to the one or more water adsorbent beds to desorb water from the one or more water absorbent beds.

4. The system of claim 1 further comprising a meter downstream of the one or more CO₂ adsorbent beds and configured to measure a content of the CO₂ desorbed from the one or more CO₂ adsorbent beds.

5. The system of claim 1, wherein the heat source is configured to generate the heat energy from waste heat from a flue gas.

6. The system of claim 1, wherein, the heat source is a waste heat recovery unit.

7. The system of claim 6, wherein the waste heat recovery unit is a heat recovery steam generation unit.

8. The system of claim 1 further comprising a blower and a dehydration unit, and the blower is configured to move the CO₂ desorbed from the one or more CO₂ adsorbent beds to the dehydration unit.

9. The system of claim 8, wherein the dehydration unit is configured to remove water entrained in the CO₂ desorbed from the one or more CO₂ adsorbent beds.

10. The system of claim 8, wherein the heat source is a heat recovery steam generation unit, and the dehydration unit is configured to send the removed water to the heat recovery steam generation unit for steam generation.

11. A process comprising:
adsorbing, by one or more CO₂ adsorbent beds in fluid communication with an air cooled heat exchanger, CO₂ from a CO₂ containing gas stream;
providing, by a heat source, heat energy to the one or more CO₂ adsorbent beds to desorb the CO₂ from the one or more CO₂ adsorbent beds; and
compressing, by a sequestration compression unit, the CO₂ desorbed from the one or more CO₂ adsorbent beds.

12. The process of claim 11 further comprising adsorbing, by one or more water adsorbent beds in fluid communication with the air cooled heat exchanger, water from the CO₂ containing gas stream.

13. The process of claim 12 further comprising providing, by the heat source, the heat energy to the one or more water adsorbent beds to desorb water from the one or more water absorbent beds.

14. The process of claim 11 further comprising measuring, by a meter downstream of the one or more CO₂ adsorbent beds, a content of the CO₂ desorbed from the one or more CO₂ adsorbent beds.

15. The process of claim 11, wherein providing the heat energy comprises generating the heat energy from waste heat from a flue gas.

16. The process of claim 11 further comprising generating additional heat energy from the desorbed water from the one or more water adsorbent beds.

17. The process of claim 16 further comprising sending the additional heat energy to the heat source, and the heat source is a heat recovery steam generation unit.

18. The process of claim 11 further comprising moving the CO₂ desorbed from the one or more CO₂ adsorbent beds, by a blower, to a dehydration unit.

19. The process of claim 11 further comprising removing, by a dehydration unit, water entrained in the CO₂ desorbed from the one or more CO₂ adsorbent beds.

20. The process of claim 19 further comprising sending the removed water from the dehydration unit to the heat source for steam generation, and the heat source is a heat recovery steam generation unit.
